(19) United States
(12) Patent Application Publication
(10) Pub. No.: US 2012/0281254 A1
(43) Pub. Date: Nov. 8, 2012

(54) GENERATION AND REGENERATION OF WEB APPLICATION PAGES FOR PRINTING

(75) Inventor: John M. Boyer, Victoria (CA)

(73) Assignee: INTERNATIONAL BUSINESS MACHINES CORPORATION, Armonk, NY (US)

(21) Appl. No.: 13/101,313

(22) Filed: May 5, 2011

(51) Int. Cl. G06F 15/00

(52) U.S. Cl. 358/1.16

(57) ABSTRACT

A computer implemented method for generating a printable electronic document for a plurality of web pages from a web application, can include for each web page of the plurality of web pages from the web application receiving, by the web application, in-progress transaction record data, receiving access to print cache content associated with the in-progress transaction record data, obtaining, from the print cache content, a snapshot of data for the web page, obtaining a subset of the in-progress transaction record data that is referenced by a web page template, comparing, with a processing device used by the web application, the snapshot of data in the print cache and the subset of the in progress data that is referenced by the web page template, selecting at least one of regenerating an electronic document printable page for the web page and retrieving a previously-generated electronic document printable page for the web page from the print cache content, and adding at least one of the regenerated electronic document printable page and the retrieved electronic document printable page to the printable electronic document.

### BACKGROUND

The present invention relates to web application print functions, and more specifically, to systems and methods of regenerating and generating web pages for printing.

Data processing of web applications is often described by large schemas (e.g., in systems designed around vertical industry standardization efforts in healthcare and insurance). The data instances in the aforementioned systems must often use multiple pages to collect data incrementally. The user is often provided with a way to incrementally update save data for a transaction and to complete the full transaction over multiple interaction sessions. Moreover, the web application may need to produce paper copies of the transaction, for example to capture wet signatures on the transaction agreement. For example, in complex insurance applications executed by an insurance agent and a customer, a primary user (e.g. the insurance agent) will have the tendency to frequently execute the print function of the web application to produce a PDF or other similar electronic document representing the transaction up to that point. The document, which may contain many pages, serves as a review copy for the transaction stakeholder (e.g. the insurance customer). The electronic document may be generated many times by the web application user, many times after only small incremental updates have been performed. For example, the web application user may provide updates for only one web page of the application, even if the web application contains many web pages that correspond to many pages of the electronic document. The net effect is that the request reprints (i.e., generates a digital rendition of) many pages that do not change.

The page print operation, which generates a digital rendition of a web page of a web application, is computationally expensive.

### SUMMARY

Exemplary embodiments include a computer implemented method for generating a printable electronic document for a plurality of web pages from a web application, the method including for each web page of a plurality of web pages from the web application receiving, by the web application, in-progress transaction record data, receiving access to print cache content associated with the in-progress transaction record data, obtaining, from the print cache content, a snapshot of data for the web page, obtaining a subset of the in-progress transaction record data that is referenced by a web page template, comparing, with a processing device used by the web application, the snapshot of data in the print cache and the subset of the in progress data that is referenced by the web page template, selecting at least one of regenerating an electronic document printable page for the web page and retrieving a previously-generated electronic document printable page for the web page from the print cache content, and adding at least one of the regenerated electronic document printable page and the retrieved electronic document printable page to the printable electronic document.

Additional exemplary embodiments include a computer program product including a non-transitory, computer readable medium storing instructions for causing a computer to implement a method for generating a printable electronic document for a plurality of web pages from a web application. The method can include for each web page of a plurality of web pages from the web application receiving, by the web application, in-progress transaction record data, receiving access to print cache content associated with the in-progress transaction record data, obtaining, from the print cache content, a snapshot of data for the web page, obtaining a subset of the in-progress transaction record data that is referenced by a web page template, comparing, with a processing device used by the web application, the snapshot of data in the print cache and the subset of the in progress data that is referenced by the web page template, selecting at least one of regenerating an electronic document printable page for the web page and retrieving a previously-generated electronic document printable page for the web page from the print cache content, and adding at least one of the regenerated electronic document printable page and the retrieved electronic document printable page to the printable electronic document.

Further exemplary embodiments include a system for generating a printable electronic document for a plurality of web pages from a web application, the system can include a processor configured to, for each web page of a plurality of web pages from the web application receiving, by the web application, in-progress transaction record data, receiving access to print cache content associated with the in-progress transaction record data, obtaining, from the print cache content, a snapshot of data for the web page, obtaining a subset of the in-progress transaction record data that is referenced by a web page template, comparing, with a processing device used by the web application, the snapshot of data in the print cache and the subset of the in progress data that is referenced by the web page template, selecting at least one of regenerating an electronic document printable page for the web page and retrieving a previously-generated electronic document printable page for the web page from the print cache content, and adding at least one of the regenerated electronic document printable page and the retrieved electronic document printable page to the printable electronic document.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1A illustrates a block diagram for a web page generator function in accordance with exemplary embodiments;

FIG. 1B illustrates a block diagram for the web page generator function of FIG. 1A in further detail;

FIG. 2A illustrates a block diagram for a page print generator function in accordance with exemplary embodiments;

FIG. 2B illustrates a block diagram for the page print generator function of FIG. 2A in further detail;

FIG. 3 illustrates a system diagram of a web application with an exemplary print generator function;

FIG. 4 illustrates a flow chart for a printing method 400 in accordance with exemplary embodiments; and

FIG. 5 illustrates an exemplary embodiment of a system that can be implemented with the exemplary printing methods.

### DETAILED DESCRIPTION

Exemplary embodiments include systems and methods for determining, for which web pages of a web application, the corresponding electronic document pages that must be regenerated versus for which web pages previously-generated electronic document pages can be used. In exemplary embodiments, the systems and methods described herein search for at least one data instance whose content is collected by multiple web pages of the web application. Web applications can include a print operation and several web page templates relevant to that print operation. For a given transaction record being created by the web application, the print operation generates electronic documents, such as PDFs, that correspond to a plurality of web page templates as filled in by the transaction record data. The data may have been collected from an end-user using alternative web page templates, or the same web page templates may have been used to collect the data and to define the print operation. The end-user is expected to make more than one print request, corresponding to various incremental updates of the transaction record. The systems and methods described herein mitigate the cost of regenerating those electronic documents corresponding to the web pages that bind to parts of the transaction record data that have not been changed by incremental updates.

Servicing a web application print request for a transaction includes constructing the aggregation of electronic print documents corresponding to web pages of the web application, as filled in by the specific transaction's data. At the end of a print request, a print cache associated with a transaction has the latest electronic print documents associated with the web pages. In exemplary embodiments, to service the next print request for the transaction, whose data may have been updated to a greater or lesser degree since the prior printing, the systems and methods described herein determine which web pages need regenerated electronic documents versus those pages whose cached electronic documents can be implemented for printing.

In exemplary embodiments, the systems and methods described herein detect whether the data delta, since the last print request, affects the presentation of a given web page. The list of data references made by each web page template is pre-computed and stored. In exemplary embodiments, the delta is computed between the current transaction record data and the transaction record data at the time of last print. Then, the delta is compared with the reference list for a given web page to see whether anything in the delta is referenced by the web page. If so, then a new electronic print document for the web page is generated, cached and used; otherwise, the cached copy is used. In further exemplary embodiments, the transaction record data is pruned, for each web page, down to the portion referenced by that web page. The pruned data is compared to that associated with the last generated electronic print document. If the pruned data has not been changed, then the cached copy of the electronic print document is used; otherwise, a new electronic print document for the web page is generated, cached and used.

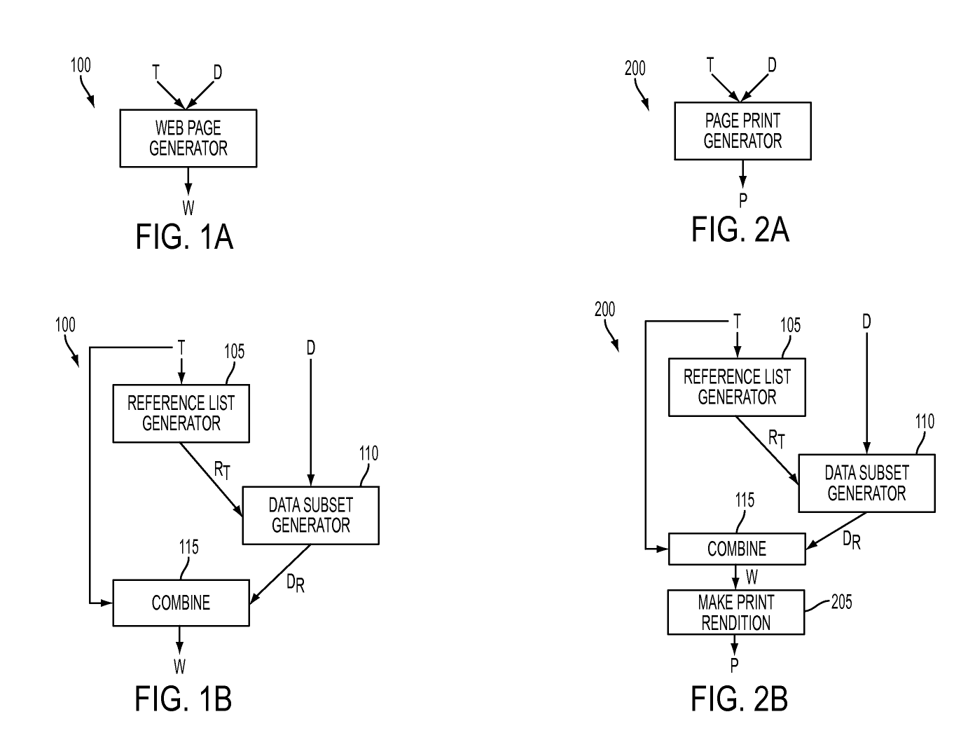

FIG. 1A illustrates a block diagram for a web page generator function 100 in accordance with exemplary embodiments. FIG. 1B illustrates a block diagram for the web page generator function 100 of FIG. 1A in further detail. T represents a web page template and R represents a list of references to data, the references being in the web page template T. As described further herein, a reference list generator 105 produces the list of references to data R_{T} made by the web page template T.

In exemplary embodiments, as part of deploying any web page template T into a web application, the systems and methods described herein auto-generate and store a list of data references R made by the web page. For example, in the case of web pages containing XForms models and form controls (Xforms is an extensible markup language (XML) format for the specification of a data processing model for XML data and user interface(s) for the XML data, such as web forms), the data references are obtained by pre-order depth first traversal of the parse tree of the web page, recording the XPath (i.e., a query language for selecting nodes from an XML document) references in model and user interface bindings of the various XForms binds and form controls as well as references in the model item properties (e.g. the calculate and relevant attributes). For example, in the case of the xforms:repeat function in Xforms, which dynamically generates user interface by matching a “nodeset” expression to data, the nodeset expression is recorded as the reference. Any references that are relative are converted to absolute references, which is done by inspection of the references made by ancestor container controls (Xforms group, switch or repeat). The ancestor controls are efficiently obtained since they are on the stack of the depth first traversal method. The running absolute path of the immediate ancestor is maintained in parallel to the pushing and popping of the depth first search stack so that any relative reference can be converted to an absolute reference using only the relative reference and the running absolute path.

Referring still to FIGS. 1A and 1B, D represents the in-progress transaction record data. A data subset generator 110 receives the in-progress transaction record data D and the list of data references R_{T} made by the web page template T, to produce a subset of data D reference by T. The subset of data D referenced by T is denoted D_{R}. A combiner 115 receives the web page template T and the data subset D_{R}. The combination of the web page template T and its run-time transaction data D_{R} is denoted a “web page” W. The “web page” W can be expressed in a web standards-based language such as extensible hypertext markup language+Xforms ((X)HTML+XForms), or it could be expressed using another format such as extensible forms description language (XFDL), which is a Lotus Forms electronic forms markup that includes XForms. FIG. 2A illustrates a block diagram for a page print generator function 200 in accordance with exemplary embodiments. FIG. 2B illustrates a block diagram for the page print generator function 200 of FIG. 2A in further detail. Regardless of the form taken by the web page W, each web page template T is associated with a method for generating an electronic document P that include one or more document pages for presenting, with a paper-like countenance, the run-time transactional data content D_{R} of a web page W, and generated in a print rendition function 205. As such, the web page W is the web page that is rendered to a user and for which a print rendition is generated. P can also be a set of TIFF or PNG images.

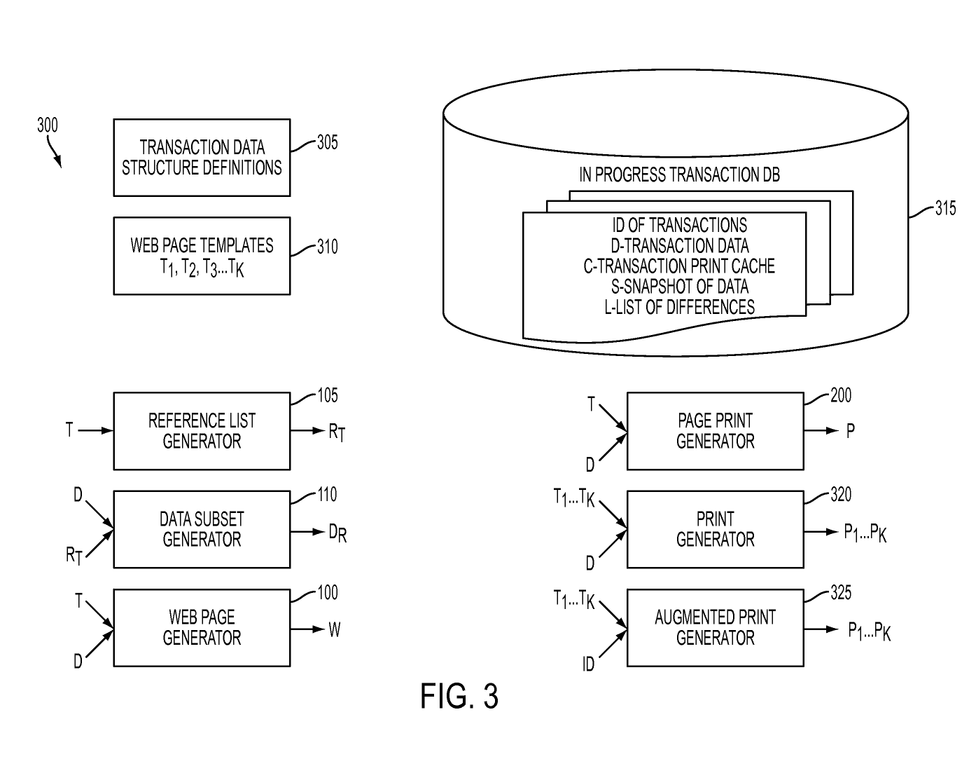

FIG. 3 illustrates a system diagram of components of a web application 300 with an exemplary print generator function. The application 300 can include transaction data structure definitions 305 that determine how the data described herein (i.e., the in-progress transaction record data D). The application 300 can further include web page templates 310, which can include the web page template T described herein. In exemplary embodiments, the components of the application 300 can further include an in-progress transaction database 315, which can include the in-progress transaction record data D, and ID of transactions and a print cache C. As further described herein, the in-progress transaction database 315 can further include a snapshot of data S and a change list of differences L. The application 300 can further include the reference list generator 105, the data subset generator 110, the web page generator 100, and the page print generator 200, the interactions of which are described herein with respect to FIGS. 1 and 2. The application 300 is further configured to print multiple web page templates T₁ . . . T_{K} with varying degrees of changes. For example, a print generator function 320 can receive the multiple web page templates T₁ . . . T_{K} as well as the in-progress transaction record data D and print multiple pages P₁ . . . P_{K} as described herein. In exemplary embodiments, the application 300 can further include an augmented print generator function 325 that further enhances print functions of multiple pages P₁ . . . P_{K} when only delta changes are made to the pages P₁ . . . P_{K}. As described further herein, several exemplary methods are implemented in order to track the delta changes as now described. As will be appreciated, the ID of transactions is input to the augmented print generator function 325 to track the delta changes and include the delta changes on the pages P₁ . . . P_{K} to be printed.

The persistent storage of each in-progress transaction of the web application 300 is equipped with the print cache C containing previously generated electronic documents (P₁ . . . P_{K}) corresponding to the web pages (W₁ . . . W_{K}). The current electronic document P representing the web page W is obtained by a simple key value (the name of) the web page template T associated with W. The print cache C also contains a snapshot S of the data D at the time of the last print request. In exemplary embodiments, the systems and methods described herein determine, at the time of a new print request, whether the cached electronic document corresponding to a web page can be provided in lieu of generating the electronic document, which includes detecting whether any changes made by updates to the transaction data D affect the given web page.

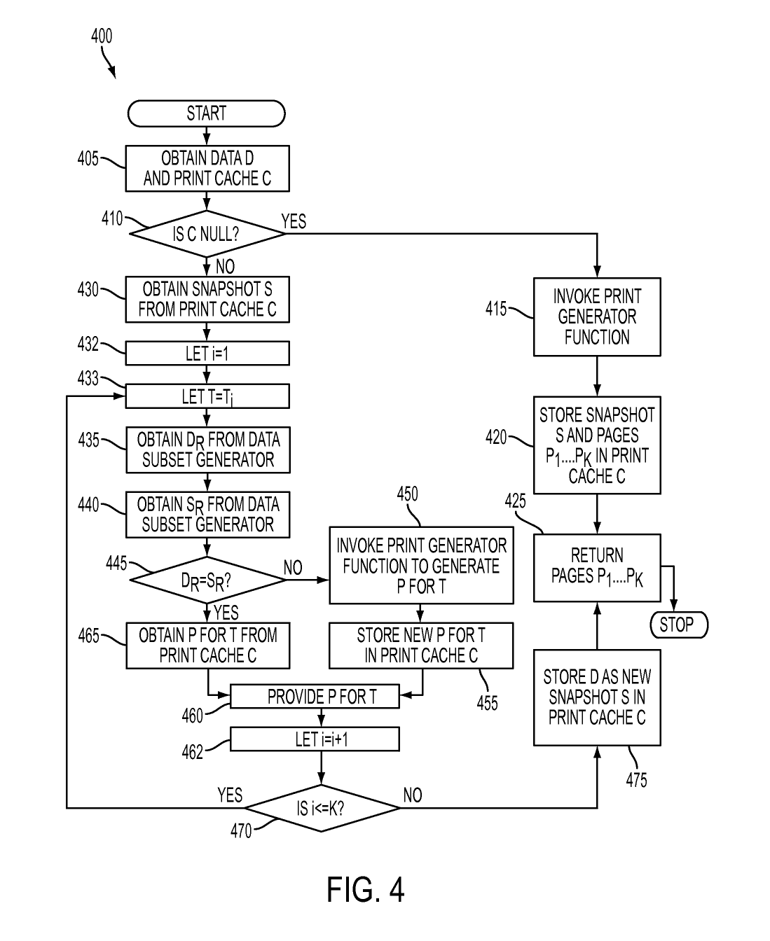

FIG. 4 illustrates a flow chart for a printing method 400 in accordance with exemplary embodiments. At block 405 the web application 300 obtains the data D and the contents of the print cache C from the database 315. At block 410, the web application 300 checks to see if the contents of the cache C are null. If the contents of the cache C are null at block 410, then at block 415, the web application 300 accesses the print generator function 200 in order to print the pages P₁ . . . P_{K}. At block 410, the web application 300 stores the snapshot S and the pages P₁ . . . P_{K} in the print cache C. Then, at block 425, the web application 300 returns the pages P₁ . . . P_{K}. If the print cache C is not null at block 410, then at block 430, the web application 300 obtains the snapshot S from the print cache C. At block 432, the web application 300 lets i=1, and at block 433, the web application 300 lets T=Tᵢ Then at block 435, the web application 300 obtains the data D_{R} from the data subset generator 110. At block 440, the web application 300 obtains the data S_{R} from the data subset generator 110. In exemplary embodiments, the web application keeps the list L, storing the absolute differences in the data, which determines the change delta. As such, both D_{R} and S_{R} are compared at block 445. It is note that, in exemplary embodiments, at block 430, a null result is produced for the snapshot in the case of a first time print so that the snapshot subset is unequal to the data subset at block 445. If at block 445 D_{R} and S_{R} are not equal, then at block 450, the web application 300 accesses the print generator function 200 to generate the web page P for the web page template T. Then at block 455, the web application 300 stores the new page P for the web template T in the print cache C. At block 460, the web application 300 provides the page P for the web template T. On the other hand, if at block 445, D_{R} and S_{R} are equal, then at block 465, the web application 300 obtains the page P for the web page template T from the print cache C. Then, at block 460, the web application 300 provides the page P for the web template T. At block 462, the web application 300 lets i=i+1 so that the method 400 advances to the next web page template. At block 470, the web application 300 determines if there are any additional web page templates Tᵢ to process, by determining if i<=K to determine whether there are any additional web page templates to process. If there are additional web page templates to process at block 470, then the method 400 returns to block 435 as described above. If there are no additional web page templates to process at block 470, then at block 475, the web application 300 stores the data D as the new snapshot S in the print cache C. Then, at block 425, the web application 300 returns the pages P₁ . . . P_{K}.

The decision block 445 can be implemented in numerous exemplary ways. In exemplary embodiments, the overall change list L is computed for all differences for the current data D and the snapshot S, which provides data for all the web page templates T. For each of the web page templates T, there is an associated reference list R, and the web application 300 computes an intersection between R and L. If the intersection of R and L is empty, then D_{R} would equal S_{R} if they were computed directly, so the cached copy of the digital printout of the page P for web page W=(T, D_{R}) can be used. If the intersection of R and L is not empty, then D_{R} has changed relative to S_{R}, so a new copy of the digital printout of the page P is computed and stored in the print cache C as described above. As such, the method 400 includes a simultaneous traversal of the print cache snapshot S and the current web application transaction data D to determine the delta, which takes the form of the list L of absolute references to changes in the data. If the character content of a leaf data node has changed (i.e., the content in S does not lexicographically equal the content for the node in D), then an absolute reference to the node is added to L. If a structural change has been made to the data (i.e., if an internal node has more or fewer children) then an absolute reference is constructed for the added or deleted child node in such a way as to match the xforms:repeat nodeset expression stored in references lists (e.g., R_{S}). The reference indicates the child node by name but without a numeric predicate reference to which child it is.

For a particular web page W, the intersection of L and R is determined. The first match, if any, stops the search and a new electronic document P is generated for the web page W and stored in the print cache C. However, if there are no matches (i.e., the intersection of L and R is empty), then no print cache update is performed on the electronic document P representing the actual web page W.

In exemplary embodiments, the results of the intersection of L and R for all web pages W_{K} is a set of electronic documents P_{K} that, in aggregate, include the desired result of the web application print function for an in-progress transaction. Thus, the last step is to store the current data D in the print cache C as the new snapshot S so that future print requests for the same transaction can be enhanced as described herein in accordance with exemplary embodiments.

As additional optional (dependent) components, the web application 300 may determine when a transaction is completed and there is no further possibility of end-user interaction with the transaction data D. The web application 300 can optionally store the final electronic document set (D_{K}) but otherwise deletes the print cache C (i.e. removes all data D and snapshots S for the transaction from the overall web application print cache). The web application 300 can also delete the print cache C if a long enough period has elapsed that the transaction data D itself is deemed abandoned. This option is controlled by a web application configuration setting, and a sample setting value would be one month with no actions or updates performed on the transaction data D.

The decision block 445 can be implemented in another exemplary manner. In determining D_{R}=S_{R}, a “hash” of D_{R} and S_{R} are stored in the print cache C for each page P_{K}. As such, rather than storing one snapshot S for the data D in the print cache C, as is done in block 475, each digital printout of the page P_{K} for a web page template T_{K}=(W_{K}, D_{R}) has an associated value hash(S_{R}). To make the logical decision whether D_{R}=S_{R}, D_{R} is computed from D, then the hash(D_{R}) is computed, which is then compared to the stored value hash(S_{R}). If hash(D_{R}) is equal to hash(S_{R}), then the cached digital printout of the page P_{K} is used. Finally, in the case where hash(D_{R}) is not equal to hash(S_{R}), the digital printout of the page P_{K} is recomputed. In addition, the hash(D_{R}) is also computed so hash(D_{R}) becomes the new hash(S_{R}) that is to be stored in the transaction print cache C along with P_{K} as an implicit part of block 455 and in lieu of block 475.

During the process described above, when an electronic document P is first generated for W and placed in print cache C, the hash is also placed there in association with P. For any future request for the electronic document P associated with web page W, the current D_{R} data is once again obtained and the digest hash H′ computed. The value of H′ is compared with H, and if equal, then the version of the electronic document P stored for W is used. Otherwise, an updated version of P is generated and stored in print cache C, along with the updated hash value H′.

It is appreciated that other exemplary methods for determining D_{R}=S_{R} are contemplated.

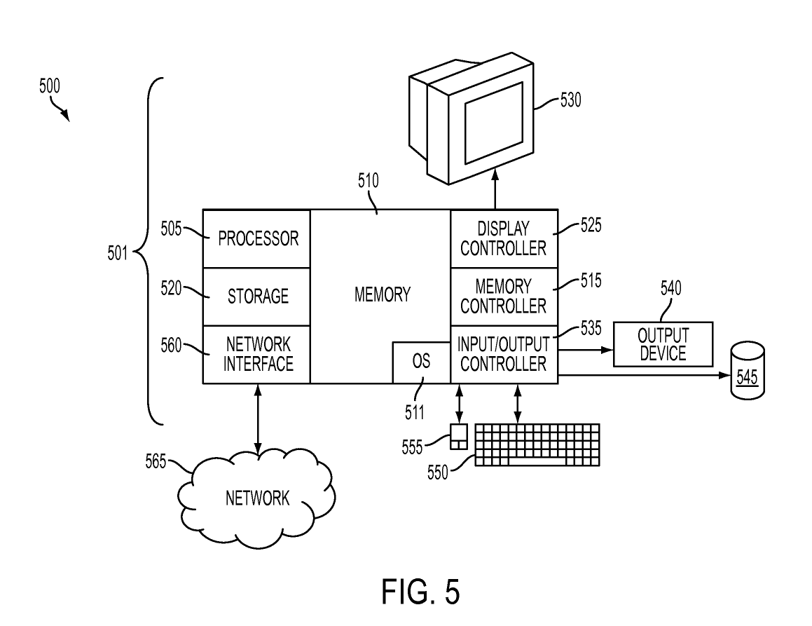

The exemplary methods described herein including the various functions such as the web page generator 100 and the page print generator 200 and the various functions associated with the web page generator 100 and the page print generator 200 can be advantageously implemented in a suitable computing system having a processor and memory. In addition, various aspects of the exemplary embodiments described herein, such as the in-progress transaction database 315 can be advantageously stored in a memory of the suitable computing system. An exemplary computing system is now described. FIG. 5 illustrates an exemplary embodiment of a system 500 that can be implemented with the exemplary printing methods described herein. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 500 therefore includes general-purpose computer 501.

In exemplary embodiments, in terms of hardware architecture, as shown in FIG. 5, the computer 501 includes a processor 505, memory 510 coupled to a memory controller 515, and one or more input and/or output (I/O) devices 540, 545 (or peripherals) that are communicatively coupled via a local input/output controller 535. The input/output controller 535 can be, but is not limited to, one or more buses or other wired or wireless connections, as is known in the art. The input/output controller 535 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 505 is a hardware device for executing software, particularly that stored in memory 510. The processor 505 can be any custom made or commercially available processor, a central processing unit (CPU), an auxiliary processor among several processors associated with the computer 501, a semiconductor based microprocessor (in the form of a microchip or chip set), a macroprocessor, or generally any device for executing software instructions.

The memory 510 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, and/or other types of storage media. Note that the memory 510 can have a distributed architecture, where various components are situated remote from one another, but can be accessed by the processor 505.

The software in memory 510 may include one or more separate programs, each of which comprises an ordered listing of executable instructions for implementing logical functions. In the example of FIG. 5, the software in the memory 510 includes the printing methods described herein in accordance with exemplary embodiments and a suitable operating system (OS) 511. The OS 511 essentially controls the execution of other computer programs, such the printing systems and methods as described herein, and provides scheduling, input-output control, file and data management, memory management, and communication control and related services.

The printing methods described herein may be in the form of a source program, executable program (object code), script, or any other entity comprising a set of instructions to be performed. When a source program, then the program needs to be translated via a compiler, assembler, interpreter, or the like, which may or may not be included within the memory 510, so as to operate properly in connection with the OS 511. Furthermore, the printing methods can be written as an object oriented programming language, which has classes of data and methods, or a procedure programming language, which has routines, subroutines, and/or functions.

In exemplary embodiments, a conventional keyboard 550 and mouse 555 can be coupled to the input/output controller 535. Other output devices such as the I/O devices 540, 545 may include input devices, for example but not limited to a printer, a scanner, microphone, and the like. Finally, the I/O devices 540, 545 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 500 can further include a display controller 525 coupled to a display 530. In exemplary embodiments, the system 500 can further include a network interface 560 for coupling to a network 565. The network 565 can be an IP-based network for communication between the computer 501 and any external server, client and the like via a broadband connection. The network 565 transmits and receives data between the computer 501 and external systems. In exemplary embodiments, network 565 can be a managed IP network administered by a service provider. The network 565 may be implemented in a wireless fashion, e.g., using wireless protocols and technologies, such as WiFi, WiMax, etc. The network 565 can also be a packet-switched network such as a local area network, wide area network, metropolitan area network, Internet network, or other similar type of network environment. The network 565 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 501 is a PC, workstation, intelligent device or the like, the software in the memory 510 may further include a basic input output system (BIOS) (omitted for simplicity). The BIOS is a set of essential software routines that initialize and test hardware at startup, start the OS 511, and support the transfer of data among the hardware devices. The BIOS is stored in ROM so that the BIOS can be executed when the computer 501 is activated.

When the computer 501 is in operation, the processor 505 is configured to execute software stored within the memory 510, to communicate data to and from the memory 510, and to generally control operations of the computer 501 pursuant to the software. The printing methods described herein and the OS 511, in whole or in part, but typically the latter, are read by the processor 505, perhaps buffered within the processor 505, and then executed.

When the systems and methods described herein are implemented in software, as is shown in FIG. 5, the methods can be stored on any computer readable medium, such as storage 520, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the printing methods are implemented in hardware, the printing methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include but are not limited to an enhanced printing function that mitigates the cost of regenerating those electronic documents corresponding to the web pages that bind to parts of the transaction record data that have not been changed by incremental updates. As such, CPU utilization is greatly reduced because, for example, the number of CPU cores that have to be reserved for generating repetitive pdfs are reduced.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer implemented method for generating a printable electronic document for a plurality of web pages from a web application, the method comprising:
for each web page of a plurality of web pages from the web application:
receiving, by the web application, in-progress transaction record data;
receiving access to print cache content associated with the in-progress transaction record data;
obtaining, from the print cache content, a snapshot of data for the web page;
obtaining a subset of the in-progress transaction record data that is referenced by a web page template;
comparing, with a processing device used by the web application, the snapshot of data in the print cache and the subset of the in progress data that is referenced by the web page template;
selecting at least one of regenerating an electronic document printable page for the web page and retrieving a previously-generated electronic document printable page for the web page from the print cache content; and
adding at least one of the regenerated electronic document printable page and the retrieved electronic document printable page to the printable electronic document.

2. The method as claimed in claim 1 wherein the snapshot of data in the print cache content is a copy of data from an in-progress transaction record obtained during a prior request to generate a printable electronic document for a plurality of web pages from a web application.

3. The method as claimed in claim 1 wherein the web page template includes a reference list describing how the web page template references the in-progress transaction record data

4. The method as claimed in claim 3 wherein comparing, with a processing device used by the web application, the snapshot of data in the print cache and the subset of the in progress data that is referenced by the web page template, comprises:
generating a change list of differences between the in-progress data from the web application and a snapshot of data in the print cache; and
computing an intersection between the reference list and the change list of differences.

5. The method as claimed in claim 4 further comprising:
in response to the intersection between the reference list and the change list of differences being empty, retrieving from the print cache the electronic document printable page associated with the web page; and
in response to the intersection between the reference list and the change list of differences being non-empty, generating a new copy of the electronic document printable page associated with the web page and storing the new copy of the electronic document printable page in the print cache.

6. The method as claimed in claim 3 wherein comparing, with a processing device used by the web application, the snapshot of data in the print cache and the subset of the in progress data that is referenced by the web page template, comprises:
calculating a first hash of the subset of the in-progress data that is referenced by the web page template;
calculating a second hash of the subset of the snapshot of data that is referenced by the web page template; and
comparing the first hash and the second hash.

7. The method as claimed in claim 6 further comprising:
in response to the first hash and the second hash being equal, retrieving from the print cache the electronic document printable page associated with the web page; and
in response to the first hash and the second hash not being equal, generating a new copy of the electronic document page associated with the web page and storing the new copy of the electronic document printable page in the print cache.

8. A computer program product including a non-transitory, computer readable medium storing instructions for causing a computer to implement a method for generating a printable electronic document for a plurality of web pages from a web application, the method comprising:
for each web page of a plurality of web pages from the web application:
receiving, by the web application, in-progress transaction record data;
receiving access to print cache content associated with the in-progress transaction record data;
obtaining, from the print cache content, a snapshot of data for the web page;
obtaining a subset of the in-progress transaction record data that is referenced by a web page template;
comparing, with a processing device used by the web application, the snapshot of data in the print cache and the subset of the in progress data that is referenced by the web page template;
selecting at least one of regenerating an electronic document printable page for the web page and retrieving a previously-generated electronic document printable page for the web page from the print cache content; and
adding at least one of the regenerated electronic document printable page and the retrieved electronic document printable page to the printable electronic document.

9. The computer program product as claimed in claim 8 wherein the snapshot of data in the print cache content is a copy of data from an in-progress transaction record obtained during a prior request to generate a printable electronic document for a plurality of web pages from a web application.

10. The computer program product as claimed in claim 8 wherein the web page template includes a reference list describing how the web page template references the in-progress transaction record data.

11. The computer program product as claimed in claim 10 wherein comparing, with a processing device used by the web application, the snapshot of data in the print cache and the subset of the in progress data that is referenced by the web page template, comprises:
generating a change list of differences between the in-progress data from the web application and a snapshot of data in the print cache; and
computing an intersection between the reference list and the change list of differences.

12. The computer program product as claimed in claim 11 wherein the method further comprises:
in response to the intersection between the reference list and the change list of differences being empty, retrieving from the print cache the electronic document printable page associated with the web page; and
in response to the intersection between the reference list and the change list of differences being non-empty, generating a new copy of the electronic document printable page associated with the web page and storing the new copy of the electronic document printable page in the print cache.

13. The computer program product as claimed in claim 10 wherein comparing, with a processing device used by the web application, the snapshot of data in the print cache and the subset of the in progress data that is referenced by the web page template, comprises:
calculating a first hash of the subset of the in-progress data that is referenced by the web page template;
calculating a second hash of the subset of the snapshot of data that is referenced by the web page template; and
comparing the first hash and the second hash.

14. The computer program product as claimed in claim 13 further comprising:
in response to the first hash and the second hash being equal, retrieving from the print cache the electronic document printable page associated with the web page; and
in response to the first hash and the second hash not being equal, generating a new copy of the electronic document page associated with the web page and storing the new copy of the electronic document printable page in the print cache.

15. A system for generating a printable electronic document for a plurality of web pages from a web application, the system comprising:
a processor configured to:
for each web page of a plurality of web pages from the web application: receiving, by the web application, in-progress transaction record data;
receiving access to print cache content associated with the in-progress transaction record data;
obtaining, from the print cache content, a snapshot of data for the web page;
obtaining a subset of the in-progress transaction record data that is referenced by a web page template;
comparing, with a processing device used by the web application, the snapshot of data in the print cache and the subset of the in progress data that is referenced by the web page template;
selecting at least one of regenerating an electronic document printable page for the web page and retrieving a previously-generated electronic document printable page for the web page from the print cache content; and
adding at least one of the regenerated electronic document printable page and the retrieved electronic document printable page to the printable electronic document.

16. The system as claimed in claim 15 wherein the web page template includes a reference list describing how the web page template references the in-progress transaction record data.

17. The system as claimed in claim 16 wherein comparing, with a processing device used by the web application, the snapshot of data in the print cache and the subset of the in progress data that is referenced by the web page template, comprises:
generating a change list of differences between the in-progress data from the web application and a snapshot of data in the print cache; and
computing an intersection between the reference list and the change list of differences.

18. The system as claimed in claim 17 wherein the processor is further configured to:
in response to the intersection between the reference list and the change list of differences being empty, retrieving from the print cache the electronic document printable page associated with the web page; and
in response to the intersection between the reference list and the change list of differences being non-empty, generating a new copy of the electronic document printable page associated with the web page and storing the new copy of the electronic document printable page in the print cache.

19. The system as claimed in claim 16 wherein comparing, with a processing device used by the web application, the snapshot of data in the print cache and the subset of the in progress data that is referenced by the web page template, comprises:
calculating a first hash of the subset of the in-progress data that is referenced by the web page template;
calculating a second hash of the subset of the snapshot of data that is referenced by the web page template; and
comparing the first hash and the second hash.

20. The system as claimed in claim 19 wherein the processor is further configured to:
in response to the first hash and the second hash being equal, retrieving from the print cache the electronic document printable page associated with the web page; and
in response to the first hash and the second hash not being equal, generating a new copy of the electronic document page associated with the web page and storing the new copy of the electronic document printable page in the print cache.
